(19) United States
(12) Patent Application Publication
(10) Pub. No.: US 2016/0200557 A1
(43) Pub. Date: Jul. 14, 2016

(54) VEHICLE LIFTER

(71) Applicant: Je Hwan CHO, Incheon (KR)

(72) Inventor: Je Hwan CHO, Seo-gu, Incheon (KR)

(21) Appl. No.: 14/911,072

(22) PCT Filed: Aug. 8, 2014
(86) PCT No.: PCT/KR2014/007354

§ 371 Date: Feb. 9, 2016

(30) Foreign Application Priority Data
Aug. 9, 2013 (KR) 10-2013-0095013
May 2, 2014 (KR) 10-2014-0053544

(51) Int. Cl. B66F 3/24

(52) U.S. Cl. CPC B66F 3/24

(57) ABSTRACT

Provided is a vehicle lifter that includes a first support portion that is provided to support a downside of a vehicle, a second support portion that is spaced apart from the first support portion and is provided to support the ground, and an expansion unit that connects the first support portion and the second support portion to each other and is expanded when a fluid is supplied to a closed space formed inside.

### TECHNICAL FIELD

The present invention relates to a vehicle lifter, and more particularly, to a vehicle lifter that is easily installed and is configured to maintain a stable installation state, regardless of various situations of road surfaces or positions of vehicle.

### BACKGROUND ART

A vehicle lifter is a mechanism that vertically lifts a vehicle body by the use of a gear, a screw or hydraulic pressure, and is usually provided in a vehicle trunk to exchange the tires of the vehicle or to repair and inspect the bottom of the vehicle.

Also, for more convenient use of a user as compared to a general mechanical lifter, a type provided with a lifting device dedicated motor using a vehicle power supply to automatically operate actuate the lifting device by utilizing the power of the motor is also used.

The type using the motors may pursue convenience when there is a need to repair a vehicle such as a punctured tire, and since the type is not manually operated using an operating rod for rotating a screw shaft, there is an advantage capable of reducing the waste of the force and the time for lifting the vehicle, in a case where a user is a woman or elderly.

However, in such a conventional vehicle lifter, in a non-planar condition of ground, as in the case of non-planar uneven road surfaces, a starting section of a steep slope such as uphill or downhill, or when a vehicle is caught on a speeding bump, there is a problem of difficulty of being installed in a space between ground and the vehicle bottom.

That is, when installing the lifter on the non-planar uneven road surface, since the lower end surface of the lifter only forms a small contact surface with the ground, there is a problem in that the lifter moves to damage the vehicle body during raising the lifter in an unstably installed state of the lifter or a user of operation of the lifter is in an accident.

In addition, when using the starting section of a slope steep of the uphill or downhill, that is, when the vehicle body and the road surface are not parallel to each other, since any one of the lower end and the upper end of the lifter only forms a small contact surface with ground or the bottom of the vehicle, as in the case of being installed on the non-planar road surface, there is a problem in that the lifter is unstably installed, and the lifter flows in the process of lifting the vehicle.

Further, when the vehicle is positioned on the upper side of a protrusion like a speeding bump, there is a disadvantage in which a space between ground and the downside of the vehicle is narrow, and the lifter is not installed.

### DISCLOSURE

### Technical Problem

An embodiment of the present invention is directed to solve the above-described problems described in background art, and an object thereof is to provide a vehicle lifter that is easily installed and is configured to maintain a stable installation state, regardless of various situations of road surfaces or positions of vehicle.

The embodiment of the present invention is not limited to the embodiment mentioned above, and other embodiments that have not been mentioned will be clearly understood by those skilled in the art from the following description.

### Technical Solution

According to an aspect of the present invention, there is provided a vehicle lifter that includes a first support portion provided to support a downside of a vehicle, a second support portion spaced apart from the first support portion and provided to support the ground, and an expansion unit that connects the first support portion and the second support portion to each other and is expanded when a fluid is supplied to a closed space formed inside.

Here, the first support portion and the second support portion may lift the vehicle by forming a constant contact surface between the ground and the lower surface of the vehicle, regardless of a gradient between the ground and the tire, when the fluid flows into the expansion unit.

In addition, the vehicle lifter may further include a first protector that is coupled to the outside of the first support portion to prevent damage of the first support portion, and a second protector that is coupled to the outside of the support to prevent damage of the second support portion.

At this time, two or more first coupling portions are provided on a rim portion of the first protector, two or more second coupling portions are provided on a rim portion of the second protector, and the vehicle lifter may further include two or more auxiliary supporters that are coupled to each of the first coupling portion and the second coupling portion.

Here, the auxiliary supporter may expand and contract in the other lengths, depending on the gradient between the ground and the tire when the fluid is injected into the sealed space.

At this time, the auxiliary supporter may include a first auxiliary supporter provided with one or more locking jaws, a second auxiliary supporter being in contact with the first auxiliary supporter in a longitudinal direction and provided with one or more locking grooves to which the locking jaws are inserted, and an elastic means provided in the first auxiliary supporter or the second auxiliary supporter.

Meanwhile, the first protector is greater than or equal to an area of the first support portion, the second protector is greater than or equal to an area of the second support portion, and the first protector and the second the protector may be formed in a grid shape and may be made of leather, fabric, wood or a metal material.

Meanwhile, the vehicle lifter may further include a connector that is connected so that the fluid flows into and is discharged from the expansion bag.

Here, the connector may further include an inlet provided on one side of the connection portion so that the fluid flows into the interior of the expansion unit, and an outlet provided on the other side of the connection portion so that the fluid is discharged to the outside of the expansion unit.

At this time, the vehicle lifter may further include a portable pressure vessel that is connected to the inlet so that the fluid flows into the expansion unit.

Meanwhile, the expansion unit may be made of a coated fabric in which a synthetic resin or rubber is coated on the fabric.

In addition, the expansion unit may include a first coated fabric with a coating of synthetic resin or rubber to the first fabric, a second coated fabric spaced apart from the first coated fabric and with synthetic resin or rubber coated on the second fabric, and a third fabric that connects the first fabric and the second fabric facing each other.

In addition, the expansion unit may be formed to be temporarily stored a tool used by a user on the side surface of the expansion unit, in a state in which the fluid is supplied to the connection portion and expanded.

Meanwhile, the vehicle lifter may further include a connection unit that connects the side surfaces of the plurality of expansion units to each other.

Here, the connection unit may be formed such that the fluid flows into or is discharged from a closed space formed inside.

At this time, the connection unit may be formed so that the closed space communicates with the sealed space of the expansion unit connection portion, and the fluid supplied to the expansion unit flows into the closed space together.

Meanwhile, the connection unit may be detachably connected to the side surface of the expansion unit.

At this time, when the expansion unit the connection unit are connected to each other, the sealed space of the expansion unit connection portion and the closed space formed in the connection unit are formed to communicate with each other, and may be connected to each other by a highly airtight connection member.

Further, the connection unit may be formed with a separate closed space that is not in communication with the sealed space, and may include separate liquid supply portion.

Meanwhile, the connection unit may be formed to temporarily store a tool used by a user in an upper portion of the connection unit, in a state of being connected to the expansion unit.

Meanwhile, the expansion unit may be made of a coated fabric with a synthetic resin or rubber coated on the fabric.

It should be understood that different embodiments of the invention, including those described under different aspects of the invention, are meant to be generally applicable to all aspects of the invention. Any embodiment may be combined with any other embodiment unless inappropriate. All examples are illustrative and non-limiting.

### Advantageous Effects

According to the vehicle lifter of the present invention, it is easy to install a vehicle lifter that it is possible to maintain a stable installation state, regardless of various situations of road surfaces or positions of vehicle.

The effect of the above invention is not limited to the above-mentioned effect, and other effects that have not been mentioned will be able to be clearly understood by those skilled in the art from the scope of the claims.

### BRIEF DESCRIPTION OF THE DRAWINGS

FIG. 1 is a perspective view of a vehicle lifter according to an embodiment of the present invention.

FIG. 2 is a cross-sectional view of the vehicle lifter of FIG. 1.

FIG. 3 is a cross-sectional diagram illustrating a structure of a connection portion of FIG. 2.

FIG. 4 is a use state diagram in which the vehicle lifter of FIG. 1 is disposed below the vehicle.

FIG. 5 is a use state diagram illustrating a state in which the fluid is supplied to the vehicle lifter of FIG. 1.

FIG. 6 is a use state diagram illustrating a state of using the vehicle lifter of FIG. 1 on the inclined ground.

FIG. 7 is a perspective view of a vehicle lifter according to a first modified example of the first embodiment of the present invention.

FIG. 8 is a use state diagram of the vehicle lifter of FIG. 7.

FIG. 9 is a perspective view of a vehicle lifter according to a second modified example of the first embodiment of the present invention.

FIG. 10 is an exploded perspective view of the vehicle lifter of FIG. 9.

FIG. 11 is a perspective view of a vehicle lifter according to a third modified example of the first embodiment of the present invention.

FIG. 12 is a partially cross-sectional diagram illustrating a structure for adjusting the length of an auxiliary supporter of the vehicle lifter of FIG. 11.

FIG. 13 is a partially cross-sectional diagram illustrating a structure in which the auxiliary supporter of the vehicle lifter of FIG. 11 is coupled with the protector.

FIG. 14 is a diagram illustrating a second embodiment of the vehicle lifter according to the present invention.

FIG. 15 is a diagram illustrating a cross-sectional structure of the vehicle lifter according to the present invention.

FIG. 16 is a diagram illustrating a state in which an expansion unit and a connection unit of the vehicle lifter according to the present invention are independently formed.

FIG. 17 is a diagram illustrating a state in which the sealed space and the closed space of the vehicle lifter according to the present invention are formed to be selectively in communication with each other.

FIG. 18 is a diagram illustrating a modified example of the second embodiment of the vehicle lifter according to the present invention.

FIG. 19 is a diagram illustrating a state of installing the second embodiment of the vehicle lifter according to the present invention in the lower part of the vehicle.

FIG. 20 is a diagram illustrating a state of lifting the vehicle by supplying the fluid to the second embodiment of the vehicle lifter according to the present invention in the state of FIG. 19.

FIG. 21 is a diagram illustrating a state of lifting of the vehicle by the second embodiment of the vehicular lifter according to the present invention, in a state in which the vehicle and the ground are not parallel to each other.

FIG. 22 is a diagram illustrating a state in which the second embodiment of the vehicle lifter according to the present invention is applied in the longitudinal direction of the vehicle.

FIG. 23 is a diagram illustrating a state in which the second embodiment of the vehicle lifter according to the present invention is applied in a horizontal direction of the vehicle.

FIG. 24 is a diagram illustrating the state of entirely lifting the vehicle, using the second embodiment of the vehicle lifter according to the present invention.

### BEST MODE FOR THE INVENTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various FIGS. and embodiments of the present invention.

Hereinafter, embodiments of the present invention will be described in detail with reference to the accompanying drawings. However, in the description of the present invention, already known function or configuration will not be described to clarify the subject matters of the present invention.

In addition, in the description of the present invention, since the terms indicating the direction such as front and rear or upside or downside are described to allow those skilled in the art to clearly understand the present invention, and indicates the relative directions, the scope of right is not limited thereby.

The vehicle lifter of the present invention is easily installed and is configured to maintain a stable installation state, even under the conditions of uneven road surface, as in a non-planer uneven road surface, a start section of a steep slope of uphill or downhill, or when a vehicle is caught on a speeding bump.

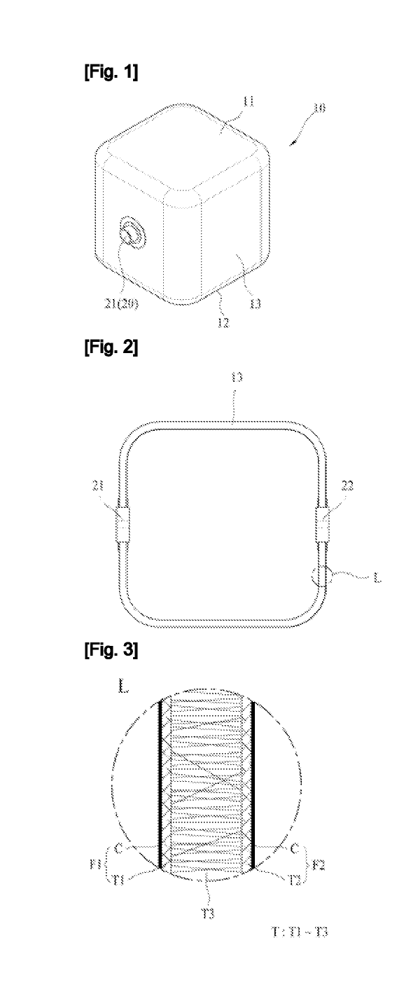

First, referring to FIGS. 1 to 13, a configuration of a first embodiment of a vehicle lifter according to the present invention will be described in detail.

FIG. 1 is a perspective view of a vehicle lifter according to an embodiment of the present invention, FIG. 2 is a cross-sectional view of the vehicle lifter of FIG. 1, and FIG. 3 is a cross-sectional diagram illustrating a structure of a connection portion of FIG. 2.

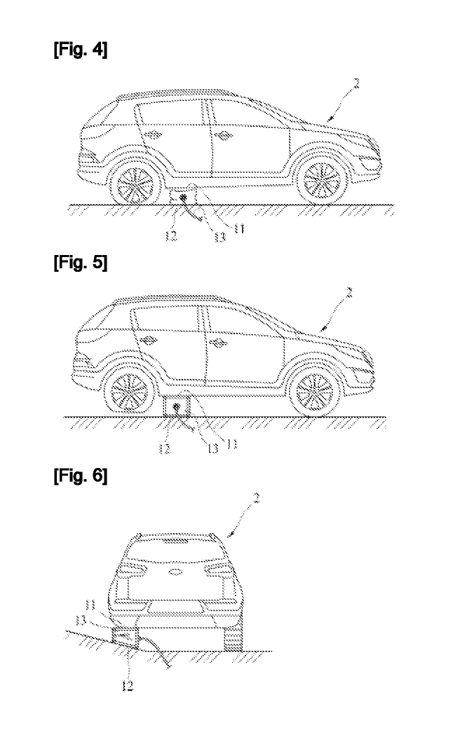

FIG. 4 is a use state diagram in which the vehicle lifter of FIG. 1 is disposed below the vehicle, FIG. 5 is a use state diagram illustrating a state in which the fluid is supplied to the vehicle lifter of FIG. 1, and FIG. 6 is a use state diagram illustrating a state of using the vehicle lifter of FIG. 1 on the inclined ground.

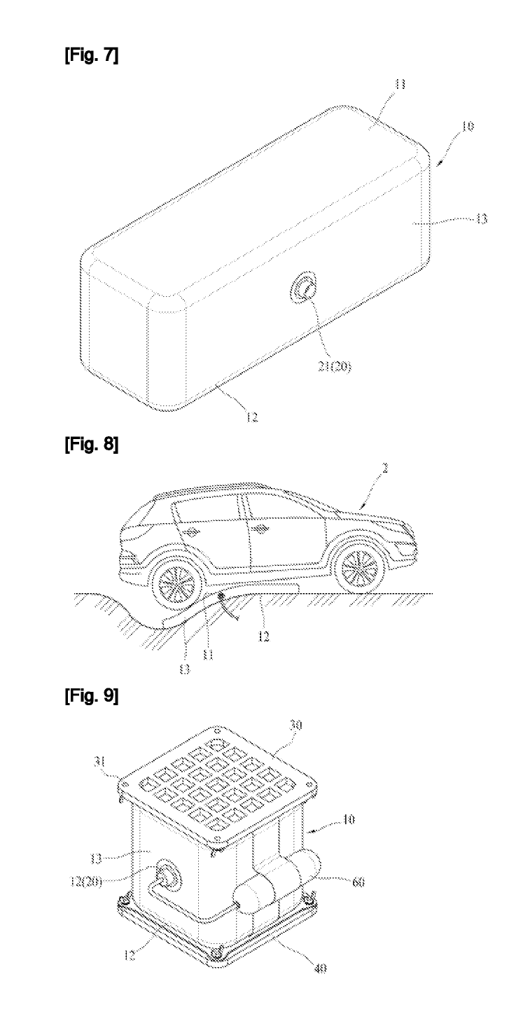

Also, FIG. 7 is a perspective view of a vehicle lifter according to a first modified example of the first embodiment of the present invention, FIG. 8 is a use state diagram of the vehicle lifter of FIG. 7, FIG. 9 is a perspective view of a vehicle lifter according to a second modified example of the first embodiment of the present invention, and FIG. 10 is an exploded perspective view of the vehicle lifter of FIG. 9.

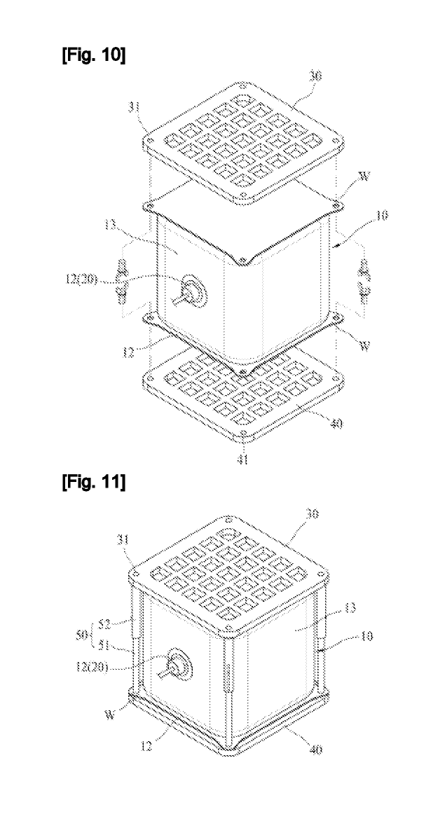

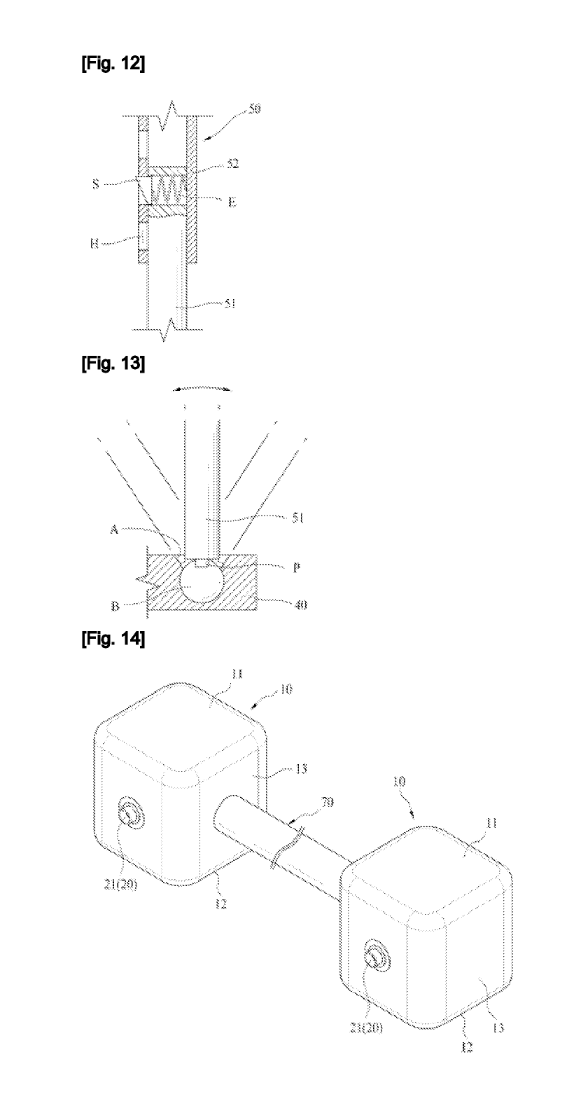

Further, FIG. 11 is a perspective view of a vehicle lifter according to a third modified example of the first embodiment of the present invention, FIG. 12 is a partially cross-sectional diagram illustrating a structure for adjusting the length of an auxiliary supporter of the vehicle lifter of FIG. 11, and FIG. 13 is a partially cross-sectional diagram illustrating a structure in which the auxiliary supporter of the vehicle lifter of FIG. 11 is coupled with the protector.

As illustrated in FIGS. 1 to 6, a vehicle lifter according to one embodiment of the present invention is a device for exchanging the tires of the vehicle 2 or lifting the vehicle body for the repair or inspection of the bottom of the vehicle 2, and is configured to include an expansion unit 10 and a connector 20.

As illustrated in FIG. 2, the expansion unit 10 has a configuration that is formed in an approximately tube shape to form a shape against the external pressure due to the pressure of the fluid flowing into an internal sealed space, and is made of a coated fabric with a synthetic resin or rubber coated on an external surface of a fabric T. The coated fabric is a kind of a fabric in which a coating layer C of synthetic resin or rubber is formed to complement strength, weather resistance, fire resistance and waterproof of the fabric T.

Further, as illustrated in FIG. 3, the expansion unit 10 may also be configured to include a first coated fabric F1 with a coating layer C of synthetic resin or rubber formed on the first fabric T1, a second coated fabric F2 spaced apart from the first coated fabric F1 and with a coating layer C of synthetic resin or rubber formed on the second fabric T2, and a third fabric T3 that connects the first fabric T1 and the second fabric T2 facing each other.

When the first coated fabric F1 is connected to the second coated fabric F2 by the third fabric T3, stress applied to the first coated fabric F1 by the weight of the vehicle body when lifting the vehicle is distributed into the second coated fabric F2 through the third fabric T3, which makes it possible to support a larger vehicle body weight such as a freight car.

Referring to FIGS. 1 and 6, the expansion unit 10 is configured to include a first support portion 11, a second support portion 12 and a connection portion 13.

The first support portion 11 is widely provided to support the downside of the vehicle 2 to form a top surface of the expansion unit 10, and the second support portion 12 is widely formed to support the ground to form a bottom surface of the expansion unit 10, and the connection portion 13 connects the first support portion 11 and the second support portion 12 to each other to form a sealed space in the interior of the expansion unit 10 into which the fluid is introduced, together with the first support portion 11 and the second support portion 12.

That is, the first support portion 11 and the second support portion 12 are made up of an approximately flat surface to support each of the frame of the vehicle 2 and the ground, and the connection portion 13 forms a lifting gap of the vehicle body between the first support portion 11 and the second support portion 12 by the internal sealed space in which the volume increases as the fluid is introduced.

As illustrated in FIG. 1, the connector 20 is an inlet and outlet through which the fluid flows into or from the expansion unit 10, and is configured to include an inlet 21 which is provided on one side of the connection 13 and through which the fluid flows into the expansion unit 10 by connection of a tube or the like on the outside, and an outlet 22 which is provided on the other side of the connection portion 13 to discharge the fluid when the use of the expansion unit 10 is completed.

Although it is not illustrated, a stopper is coupled to the inlet 21 and the outlet 22 to block the external foreign matters during storage and to prevent discharge of fluid during use, and an interruption valve is provided in the inlet 21 and the outlet 22 to interrupt the inflow and outflow of the fluid.

The vehicle lifter may be normally placed in a vehicle trunk or the like, and is stored in the minimized form of the internal sealed space at the time of storage. That is, since any one or more of the first support portion 11, the second support portion 12 and the connection portion 13 are stored in a state of being folded or formed with wrinkles, a housed space in the trunk is minimized.

As illustrated in FIGS. 4 and 5, at the time of use of the expansion unit 10, since the connection portion 13 is folded inward or outward and the gap between the first support portion 11 and the second support portion 12 may be minimized, there is an advantage capable of being easily installed in a general situation such as a flat tire, and even in a narrow gap in which a protrusion such as a speeding bump exists on the ground, and the conventional vehicle lifter cannot be installed.

As illustrated in FIG. 6, when using in a start section of a steep slope of uphill or downhill, that is, when an inclination angle is formed between the vehicle wheel and the road surface, as the fluid flows into the internal sealed space, while the first support portion 11 and the second support portion 12 form a wide contact surface with the ground and the bottom of the vehicle 2, a wrinkle is formed only one side of the connection portion 13 by the inclination angle of a road surface, thereby rigidly supporting the ground and the downside of the vehicle in a stable state.

As illustrated in FIG. 7, the expansion unit 10 of the vehicle lifter according to a first modified example of the first embodiment of the present invention can variously form the areas of the first support portion 11 and the second support portion 12, within a scope capable of being installed between the passenger car front and rear wheels.

In addition, the expansion unit 10 may be formed of various forms such as a square pillar, a cylinder, a triangular pillar and a truncated pyramid, and it is, of course, possible to variously form the areas of the first support portion 11 and the second support portion 12 and a height of the connection portion 13, depending on the type of vehicle to be used.

When the areas of the first support portion 11 and the second support portion 12 becomes wider, the volume of the expansion unit 10 for supporting the vehicle body weight increases, and it is possible to support the heavier weight. Thus, it is possible to manufacture the first support portion 11, the second support portion 12 and the connection portion 13 in various lengths, depending on the vehicle to be applied, such as a small vehicle, a medium-sized vehicle, a heavy vehicle and a specially equipped vehicle.

As illustrated in FIG. 8, the vehicle lifter according to a first modified example of the first embodiment of the present invention can be used to make the vehicle wheels escape from soil pits when the vehicle wheels fall into soil pits.

That is, when the vehicle wheels fall into soil pits, when disposing the lifter formed with the first support portion 11 and the second support portion 12 at a predetermined length or more between the vehicle wheels and the ground, it is possible to make the vehicle wheels escape from soil pits by providing a frictional force to the vehicle wheels.

Referring to FIGS. 9 and 10 again, in a vehicle lifter according to a second modified example of the first embodiment of the present invention, each of a first protector 30 and a second protector 40 can be coupled to each of the first support portion 11 and the second support portion 12. The first protector 30 is coupled to the outside of the first support portion 11 to prevent damage to the first support portion 11, and the second protector 40 is coupled to the outside of the second support portion 12 to prevent damage to the second support portion 12.

The first protector 30 has an area greater than or equal to the area of the first support portion 11 to protect the entire area of the first support portion 11, and the second protector 40 also has an area greater than or equal to the area of the support portion 12 to protect the entire area of the second support portion 12.

Further, each of the first protector 30 and the second protector 40 supports the downside of the vehicle in a state of forming a contact surface with the entire surface of the first support portion 11 and the second support portion 12, as the partial deformation of the first support portion 11 and the second support portion 12 is prevented in the process of support, even when the same fluid flows in, the vehicle body can be lifted higher, and since the weight of the vehicle body is evenly distributed over the entire area of the expansion unit 10, there is an effect in which the lifter can support the vehicle of larger weight.

The first protector 30 and a second protector 40 are formed of leather, fabric, wood or metal material formed in a grid form. When the first protector 30 and the second protector 40 is formed of in a grid form, even if protruding pieces or foreign matters are present between the ground or the downside of the vehicle, since the protectors can be installed in a state of locating the protruding pieces and the foreign matters between the grids, there is an advantage capable of easily utilized even in the ground on which uneven or foreign matters remain.

Further, since the protruding pieces or foreign matters located between the grids rather have a function of preventing slippage of the vehicle lifter, the vehicle lifter can be installed in a more rigid structure.

A coupled configuration of the protectors and the support portion is as follows. That is, two or more first coupling portions 31 are provided on the rim portion of the first protector 30, two or more second coupling portions 41 are provided on the rim portion of the second protector 40, and each of two or more wing portions W is provided on the edges of the first support portion 11 and the second support portion 12. The first coupling portion 31 and the second coupling portion 41 are formed with a screw hole, each of the wing portions W is formed with a through-hole, and the coupling portions and the wing portions are coupled to each other with bolts.

As illustrated in FIG. 9, the vehicle lifter of the present invention may further include a portable pressure vessel 60 that is connected to the inlet 21 so that the fluid flows into the expansion unit 10.

When the portable pressure vessel 60 is provided in the vehicle lifter, there is an effect capable of using the lifter anywhere, even without visiting a vehicle repair shop provided with a pressure fluid. The portable pressure container 60 is preferably provided with an intermittent valve (not illustrated) that intermits the inflow amount of the fluid.

As the portable pressure container 60 is coupled to the connection portion 13, it is possible to rapidly move and install the lifter, and the vehicle lifter can also be used in applications for rescuing a person who falls into water.

That is, in a case where a person falls into the water, when the vehicle lifter placed in the vehicle trunk is taken out and is thrown toward a person who falls into the water after opening the intermittent valve of the portable pressure vessel 60, it can be used in the application that rescues human life such as a life-saving tube by buoyancy of the vehicle lifter.

As illustrated in FIG. 11, the vehicle lifter according to a third modified example of the first embodiment of the present invention may further include two or more auxiliary supporters 50 coupled to the first coupling portion 31 and the second coupling portion 41 at both end portions.

Referring to FIGS. 11 and 12, the auxiliary supporter 50 is configured to include a first auxiliary supporter 51 provided with a locking jaw S and an elastic means E, and a second auxiliary supporter 52a having a locking groove H.

The first auxiliary supporter 51 and the second auxiliary supporter 52 are coupled to each other in a structure which is stretchable by sliding each other, the locking jaw S protrudes outward from the side surface of the supporter 51 by the elastic means E such as a spring or is drawn into the interior.

The locking jaw S passes through the locking groove H, while sliding, by forming an inclination with the locking groove H in the direction in which the length of the auxiliary supporter 50 is expanded, and is locked on the locking groove H in the direction of in which the length of the auxiliary supporter 50 is shortened.

When the auxiliary supporter 50 is installed in the vehicle lifter, the auxiliary supporter of a contracted state is stretched, while the wrinkles formed in the extension is unfolded when the fluid flows into the expansion unit 10, and when the injection of fluid is completed, the stretching of the auxiliary supporter 50 is also stopped.

The auxiliary supporter 50 is expanded and contracted to different lengths depending on the gradient between the ground and the tire when the fluid is injected into the sealed space to support the weight of the vehicle body along with the expansion unit 10. If there is a situation in which the expansion unit 10 is damaged due to external impact and the fluid flows outward, as the contraction of the auxiliary supporter 50 is prevented by coupling between the locking jaw S and the locking groove H, it is possible to continuously support the weight of the vehicle body.

As illustrated in FIG. 13, a rotating ball B formed with an insertion groove is provided in the first coupling portion 31 and the second coupling portion 41, and a protrusion P to be inserted and coupled to the insertion groove is formed at both end portions of the first auxiliary supporter 51 and the second auxiliary supporter 52.

When the vehicle lifter is installed on the inclined ground to lift the car body, even if wrinkles are formed on one side of the extension portion and two or more auxiliary supporters 50 are stretched to different lengths, as the rotating ball B inserted into the first coupling portion 31 and the second coupling portion 41 rotate within the inclination angle of the inclined portion A, the weight of the body is rigidly supported even on the inclined ground, likewise the flat ground.

Meanwhile, the expansion unit of the vehicle lifter according to first embodiment of the present invention may also be formed so that an operator can temporarily store a using tool.

Since the side portion of the expansion unit is formed in the form of being cut into the interior of the expansion unit, it is possible to ensure a space in which a tool used by the operator can be temporarily placed. Alternatively, it is possible to apply various methods such as provision of hooks on which the tool can be temporarily hooked, and the forms and configurations thereof can be varied without limitation.

According to the present invention, by providing the expansion unit 10 that includes the first support portion 11 widely provided to support the downside of the vehicle 2, the second support portion 12 spaced apart from the first support portion 11 and widely formed to support the ground, and the connection portion 13 provided an internal sealed space to connect the first support portion 11 and the second support portion 12 to each other, it is possible to provide a vehicle lifter that is easily installed and is configured to maintain a stable installation state, even under the conditions of non-planar uneven road surface, a start section of a steep slope of uphill or downhill, or when a vehicle is caught on a speeding bump.

Next, a configuration of a second embodiment of a vehicle lifter according to the present invention will be described in detail with reference to FIGS. 14 to 18.

Here, FIG. 14 is a diagram illustrating a second embodiment of the vehicle lifter according to the present invention, and FIG. 15 is a diagram illustrating a cross-sectional structure of the vehicle lifter according to the present invention.

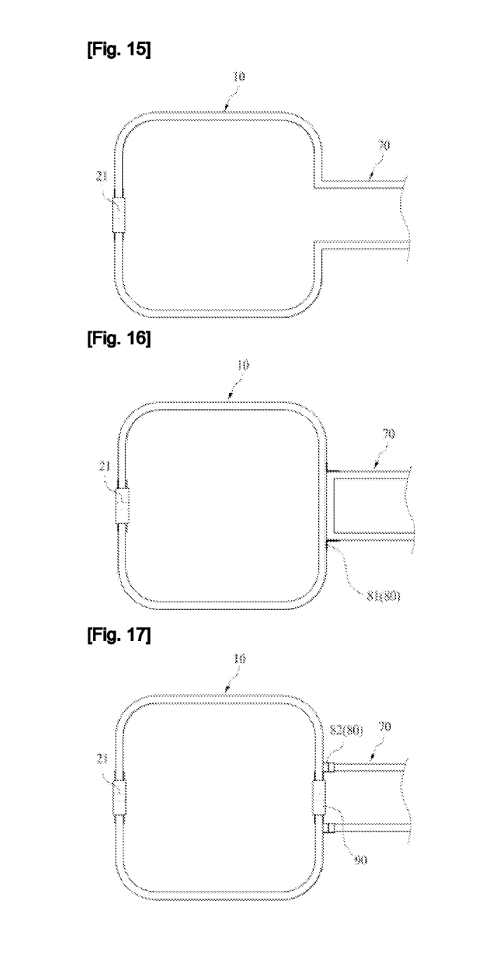

Also, FIG. 16 is a diagram illustrating a state in which an expansion unit and a connection unit of the vehicle lifter according to the present invention are independently formed, and FIG. 17 is a diagram illustrating a state in which the sealed space and the closed space of the vehicle lifter according to the present invention are formed to be selectively in communication with each other.

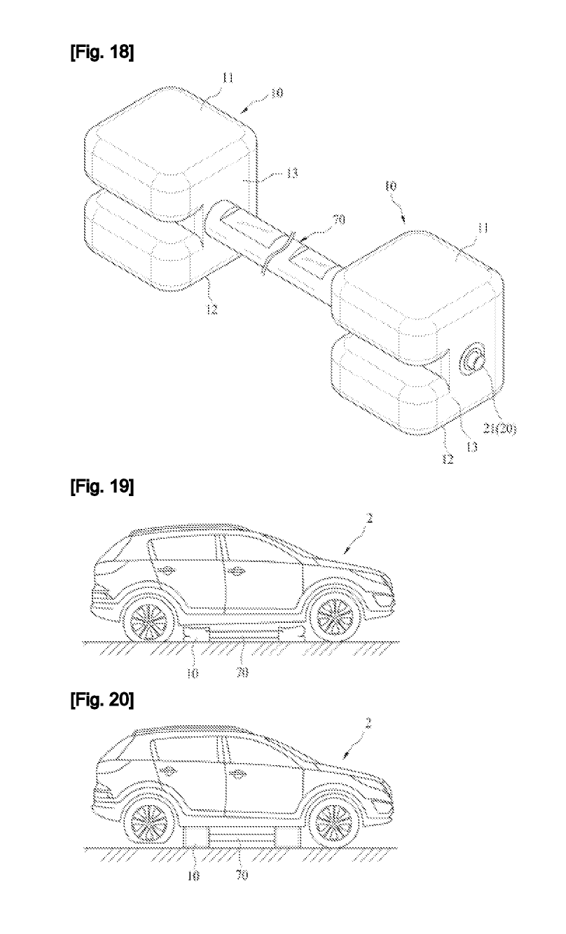

Further, FIG. 18 is a diagram illustrating a modified example of the second embodiment of the vehicle lifter according to the present invention.

As illustrated in FIGS. 14 to 17, the second embodiment of a vehicle lifter according to the present invention can include an expansion unit 10 and a connection unit 70.

The expansion unit 10 has a configuration that is formed in an approximately tube shape to form a shape against the external pressure due to the pressure of the fluid flowing into an internal sealed space, and is made of a coated fabric with a synthetic resin or rubber coated on an external surface of the fabric. The coated fabric is a kind of a fabric in which a coating layer of synthetic resin or rubber is formed to complement strength, weather resistance, fire resistance and waterproof of the fabric.

Further, the expansion unit 10 is configured to include a first support portion 11, a second support portion 12 and a connection portion 13.

The first support portion 11 is widely provided to support the downside of the vehicle 2 to form a top surface of the expansion unit 10, and the second support portion 12 is widely formed to support the ground to form a bottom surface of the expansion unit 10, and the connection portion 13 connects the first support portion 11 and the second support portion 12 to each other to form a sealed space in the interior of the expansion unit 10 into which the fluid is introduced, together with the first support portion 11 and the second support portion 12.

That is, the first support portion 11 and the second support portion 12 are made up of an approximately flat surface to support each of the frame of the vehicle 2 and the ground, the distance of the connection portion 13 between the first support portion 11 and the second support portion 12 increases by the internal sealed space in which the volume increases as the fluid is introduced, and the distance can form a gap in which the vehicle body is lifted.

Further, the expansion unit 10 may further include a connector 20 that is an inlet and outlet through which the fluid flows into or from the internal sealed space.

The connector 20 is configured to include an inlet 21 which is provided on one side of the connection 13 and through which the fluid flows into the expansion unit 10 by connection of a tube or the like on the outside, and an outlet 22 which is provided on the other side of the connection portion 13 to discharge the fluid when the use of the expansion unit 10 is completed.

Although it is not illustrated, a stopper is coupled to the inlet 21 and the outlet 22 to block the external foreign matters during storage and to prevent discharge of fluid during use, and an interruption valve can be provided in the inlet 21 and the outlet 22 to interrupt the inflow and outflow of the fluid.

Further, the expansion unit 10 can variously form the areas of the first support portion 11 and the second support portion 12, within a scope capable of being installed between the passenger car front and rear wheels.

In addition, the expansion unit 10 may be formed of various forms such as a square pillar, a cylinder, a triangular pillar and a truncated pyramid, and it is, of course, possible to variously form the areas of the first support portion 11 and the second support portion 12 and a height of the connection portion 13, depending on the type of vehicle to be used.

When the areas of the first support portion 11 and the second support portion 12 becomes wider, the volume of the expansion unit 10 for supporting the vehicle body weight increases, and it is possible to support the heavier weight. Thus, it is possible to manufacture the first support portion 11, the second support portion 12 and the connection portion 13 in various lengths, depending on the vehicle to be applied, such as a small vehicle, a medium-sized vehicle, a heavy vehicle and a specially equipped vehicle.

Further, as described above, when the first support portion 11 and the second support portion 12 have a relatively large area, the vehicle lifter can be used to make the vehicle wheels escape from soil pits when the vehicle wheels fall into soil pits, and its applications can also be various without limitation.

That is, when the vehicle wheels fall into the soil pits, when disposing the expansion unit 10 formed with the first support portion 11 and the second support portion 12 at a predetermined length or more between the vehicle wheels and the ground, it is possible to make the vehicle wheels escape from soil pits by providing a frictional force to the vehicle wheels.

Meanwhile, the connection unit 70 is a component that connects the side surfaces of the plurality of expansion units 10.

As illustrated in FIGS. 14 and 15, the connection unit 70 can be configured to be coupled to the connection portion 13 that is a side surface of the expansion unit 10 so as to connect a plurality of expansion units 10.

At this time, a hole communicating with a part of the connection portion 13 is formed on one side of the connection portion 13, and the connection unit 70 is formed in a form in which the structure of the shape surrounding the hole extends to connect the hole formed in the connection portion 13 of another expansion unit 10.

That is, the sealed spaced formed in the expansion unit 10 described above and the closed space formed in the connection unit 70 are formed in a form connected to each other, and the fluid supplied to the internal sealed space of the expansion unit 10 through the inlet 21 of the expansion unit 10 can flow into the internal closed space of the connection unit 70.

Further, likewise the expansion unit 10, the connection unit 70 has a configuration that is formed in an approximately tube shape to form a shape against the external pressure due to the pressure of the fluid flowing into an internal sealed space, and is made of a coated fabric with a synthetic resin or rubber coated on an external surface of the fabric. The coated fabric is a kind of a fabric in which a coating layer of synthetic resin or rubber is formed to complement strength, weather resistance, fire resistance and waterproof of the fabric.

Further, as illustrated in FIG. 16, the connection unit 70 is formed so that the sealed space of the expansion units 10 does not communicate with the closed space of the connection unit 70, and can be provided so as to be simply coupled to the side portion of the expansion unit 10 to connect a plurality of expansion units 10.

In such a case, the connection unit 70 can be coupled to the expansion unit 10 via a separate fixing member 80 such as Velcro 81.

In addition, as long as the fixing member 80 is provided to couple the connection unit 70 such as a tape or a fastener and the expansion unit 10, its form and configuration can be varied without being limited.

Moreover, in such a case, the connection unit 70 is advantageously further include another inlet and outlet (not illustrated) that can supply and remove fluid to the interior of the closed space of the connection unit 70.

Meanwhile, as illustrated in FIG. 17, the connection unit 70 is detachably connected to the expansion unit 10 described above, and may be provided so as to receive provision of fluid supplied to the expansion unit 10, without including a separate inlet for a supplying the fluid.

In such a case, a fixing member 80 for fixing and coupling the expansion unit 10 and the connection unit 70 is included, and at this time, the fixing member 80 is advantageously to fix the expanding unit 10 and the connection unit 70, using a fixing member with excellent sealing properties, such as a waterproof zipper 82.

Of course, as long as the fixing member 80 is provided to couple the expansion unit 10 and the connection unit 70 with high sealing properties so that the inside fluid does not flow out, such as fixing using a magnet, its shape and configuration can be varied without limitation.

In addition, the expansion unit 10 further includes a valve 90 capable of selectively controlling the movement of the fluid in a part connected to the connection unit 70, and can supply the fluid supplied to the closed space of the expansion unit 10 to the closed space of the connection unit 70.

In this way, the connections examples illustrated in FIGS. 16 and 17, since the expansion unit 10 and the connection unit 70 can be attached and detached, there may be various applicable effects such as using only the expansion unit 10 according to the needs of the users, or using a plurality of expansion units 10 by being connected with the connection unit 70.

Meanwhile, as illustrated in FIG. 18, a vehicle lifter according to a modified example of the second embodiment of the present invention may be formed so that a tool used by an operator can be temporarily stored in the expansion unit or the connection unit.

In this modified example, since the side portion of the expansion unit 10 is formed in the form of being cut into the interior of the expansion unit 10, it is possible to ensure a space in which a tool used by the operator can be temporarily placed.

Alternatively, by forming a part of the upper part of the connection unit 70 to have a flat area, it is possible to form it so that a tool used by a user can be temporarily stored.

It is possible to apply various methods such as provision of hooks on which the tool can be temporarily hooked, and the forms and configurations thereof can be varied without limitation.

Subsequently, a using aspect of the second embodiment of the vehicle lifter according to the present invention will be described in detail referring to FIGS. 19 to 24.

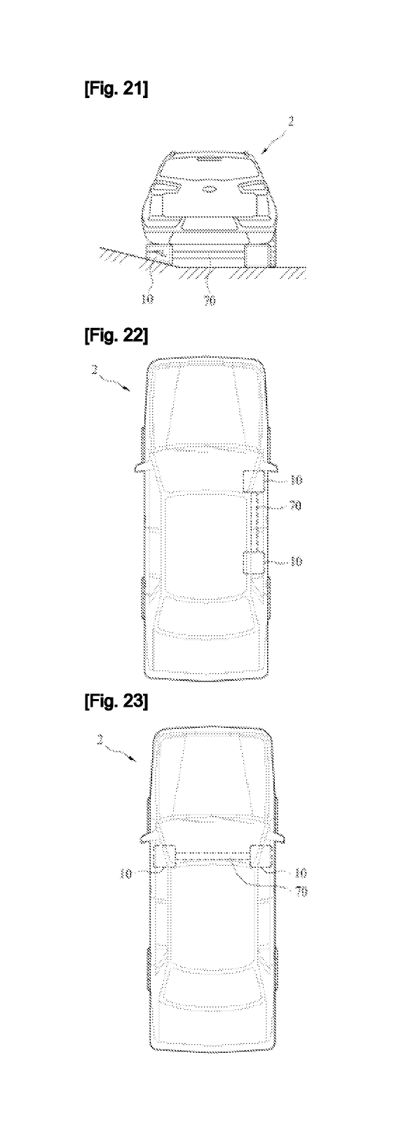

Here, FIG. 19 is a diagram illustrating a state of installing the second embodiment of the vehicle lifter according to the present invention in the lower part of the vehicle, FIG. 20 is a diagram illustrating a state of lifting the vehicle by supplying the fluid to the second embodiment of the vehicle lifter according to the present invention in the state of FIG. 19, and FIG. 21 is a diagram illustrating a state of lifting of the vehicle by the second embodiment of the vehicular lifter according to the present invention, in a state in which the vehicle and the ground are not parallel to each other.

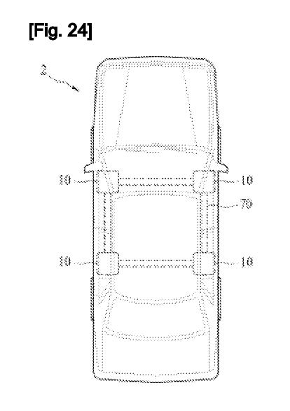

Further, FIG. 22 is a diagram illustrating a state in which the second embodiment of the vehicle lifter according to the present invention is applied in the longitudinal direction of the vehicle, FIG. 23 is a diagram illustrating a state in which the second embodiment of the vehicle lifter according to the present invention is applied in a horizontal direction of the vehicle, and FIG. 24 is a diagram illustrating the state of entirely lifting the vehicle, using the second embodiment of the vehicle lifter according to the present invention.

As illustrated in FIGS. 19 and 20, when an air pressure is insufficient in the tires of the vehicle 2 or when a problem occurs in the vehicle 2 and it is necessary to perform a work from the lower part of the vehicle, the vehicle lifter according to the present invention is disposed below the vehicle 2.

Thereafter, when injecting a fluid into the interior of the vehicle lifter, there is an effect in which the expansion unit 10 and the connection unit 70 of the present invention can lift the vehicle 2, while expanding.

Such a vehicle lifter can be normally be placed in the interior of the vehicle or the like, and is stored during storage in a state in which the sealed space of the expansion unit 10 and the closed space of the connection unit 70 is minimized. That is, since any one or more of the first support portion 11, the second support portion 12 and the connection portion 13 are stored in a state of being folded or formed with wrinkles, a housed space in the trunk is minimized.

As illustrated in FIGS. 19 and 21, at the time of use of the expansion unit 10, since the connection portion 13 is folded inward or outward and the gap between the first support portion 11 and the second support portion 12 may be minimized, there is an advantage capable of being easily installed in a general situation such as a flat tire, and even in a narrow gap in which a protrusion such as a speeding bump exists on the ground, and the conventional vehicle lifter cannot be installed.

Since such a process is relatively easily driven as compared to the existing lifter of the complicated installation and operation, there is also an effect in which anyone can use it with simple and easy installation.

Further, as illustrated in FIG. 21, when there is a need to use it in a start section of a steep slope of uphill or downhill, that is, when an inclination angle is formed between the vehicle wheel and the road surface, as the fluid flows into the internal sealed space, while the first support portion 11 and the second support portion 12 form a wide contact surface with the ground and the bottom of the vehicle 2, a wrinkle is formed only one side of the connection portion 13 by the inclination angle of a road surface, thereby rigidly supporting the ground and the downside of the vehicle in a stable state.

Meanwhile, a vehicle lifter according to the present invention is capable of supporting the vehicle 2 in different ways by the user's need.

As illustrated in FIGS. 22 to 24, the vehicle lifter according to the present invention can also be applied in the longitudinal direction of the vehicle 2 to support the vehicle 2, or the vehicle lifter vehicle according to the present invention can also be applied in a horizontal direction of the vehicle 2 to support the vehicle, and it can be used by entire supporting the vehicle 2 through a configuration that compositely connects the greater number of expansion units 10 using the connection unit 70.

At this time, in the case of a configuration in which the connection unit 70 is detachably connected to the expansion unit 10 of the configurations of the vehicle lifting of the invention described above, it is also possible to more efficiently support the vehicle 2, while more complexly forming a variety of configurations.

Through all the configurations described above, it is possible to use a vehicle lifter in which anyone relatively simply and easily install the vehicle lifter, regardless of the conditions the various road surface or the positions of vehicle, and is formed to maintain stable installation state.

While the present invention has been described with respect to the specific embodiments, it will be apparent to those skilled in the art that various changes and modifications may be made without departing from the spirit and scope of the invention as defined in the following claims.

1. A vehicle lifter comprising:
a first support portion that is provided to support a downside of a vehicle;
a second support portion that is spaced apart from the first support portion and is provided to support the ground; and
an expansion unit that connects the first support portion and the second support portion to each other and is expanded when a fluid is supplied to a closed space formed inside.

2. The vehicle lifter of claim 1, wherein the first support portion and the second support portion lift the vehicle by forming a constant contact surface between the ground and the lower surface of the vehicle, regardless of a gradient between the ground and the tire, when the fluid flows into the expansion unit.

3. The vehicle lifter of claim 1, further comprising:
a first protector that is coupled to the outside of the first support portion to prevent damage of the first support portion, and a second protector that is coupled to the outside of the support to prevent damage of the second support portion.

4. The vehicle lifter of claim 3, wherein two or more first coupling portions are provided on a rim portion of the first protector, two or more second coupling portions are provided on a rim portion of the second protector, and the vehicle lifter further comprises two or more auxiliary supporters that are coupled to each of the first coupling portion and the second coupling portion.

5. The vehicle lifter of claim 4, wherein the auxiliary supporter is configured to expand and contract in the other lengths, depending on a gradient between the ground and the tire when the fluid is injected into the sealed space.

6. The vehicle lifter of claim 5, wherein the auxiliary supporter comprises a first auxiliary supporter provided with one or more locking jaws, a second auxiliary supporter coming into contact with the first auxiliary supporter in a longitudinal direction and provided with one or more locking grooves to which the locking jaws are inserted, and an elastic means provided in the first auxiliary supporter or the second auxiliary supporter.

7. The vehicle lifter of claim 3, wherein the first protector is greater than or equal to an area of the first support portion, the second protector is greater than or equal to an area of the second support portion, and the first protector and the second the protector are formed in a grid shape and are made of leather, fabric, wood or a metal material.

8. The vehicle lifter of claim 1, further comprising:
a connector that is connected so that the fluid flows into and is discharged from the expansion bag.

9. The vehicle lifter of claim 8, wherein the connector further comprises an inlet provided on one side of the connection portion so that the fluid flows into the interior of the expansion unit, and an outlet provided on the other side of the connection portion so that the fluid is discharged to the outside of the expansion unit.

10. The vehicle lifter of claim 9, further comprising:
a portable pressure vessel that is connected to the inlet so that the fluid flows into the expansion unit.

11. The vehicle lifter of claim 1, wherein the expansion unit may include a first coated fabric with a coating of synthetic resin or rubber to the first fabric, a second coated fabric spaced apart from the first coated fabric and with synthetic resin or rubber coated on the second fabric, and a third fabric that connects the first fabric and the second fabric facing each other.

12. The vehicle lifter of claim 1, wherein the expansion unit is formed to temporarily stored a tool used by a user on the side surface of the expansion unit, in a state in which the fluid is supplied to the connection portion and expanded.

13. The vehicle lifter of claim 1, further comprising:
a connection unit that connects the side surfaces of the plurality of expansion units to each other.

14. The vehicle lifter of claim 13, wherein the connection unit is formed such that the fluid flows into or is discharged from a closed space formed inside.

15. The vehicle lifter of claim 14, wherein the connection unit is formed so that the closed space communicates with the sealed space of the expansion unit connection portion, and the fluid supplied to the expansion unit flows into the closed space together.

16. The vehicle lifter of claim 13, wherein the connection unit is detachably connected to the side surface of the expansion unit.

17. The vehicle lifter of claim 16, wherein, when the expansion unit the connection unit are connected to each other, the sealed space of the expansion unit connection portion and the closed space formed in the connection unit are formed to communicate with each other, and are connected to each other by a highly airtight connection member.

18. The vehicle lifter of claim 16, wherein the connection unit is formed with a separate closed space that is not in communication with the sealed space, and includes separate liquid supply portion.

19. The vehicle lifter of claim 13, wherein the connection unit is formed to temporarily store a tool used by a user in an upper portion of the connection unit, in a state of being connected to the expansion unit.

20. The vehicle lifter of claim 13, wherein the expansion unit is made of a coated fabric with a synthetic resin or rubber coated on the fabric.
